(19) United States
(12) Patent Application Publication
(10) Pub. No.: US 2023/0419766 A1
(43) Pub. Date: Dec. 28, 2023

(54) Systems, Methods, and Apparatuses for Operating a Modular Vending Machine

(71) Applicant: ROMAINE EMPIRE, INC., Chicago, IL (US)

(72) Inventors: Luke Saunders, Chicago, IL (US); Arne Saupe, Chicago, IL (US); Don Balis, Naperville, IL (US); Rusudan Kareli, Chicago, IL (US); William Renwick, Chicago, IL (US); Julian DeFranco, Oak Park, IL (US); Ross Brinkman, Chicago, IL (US); Gerry Mayer, Chicago, IL (US); Cole Stapleton, Chicago, IL (US); Robert Butler, Liberty Hill, TX (US); Brian Schoolcraft, Cedar Park, TX (US)

(21) Appl. No.: 18/213,359

(22) Filed: Jun. 23, 2023

Related U.S. Application Data
(60) Provisional application No. 63/355,427, filed on Jun. 24, 2022.

(51) Int. Cl. G07F 9/00

(52) U.S. Cl. CPC G07F 9/006

(57) ABSTRACT

Systems and methods for a modular configuration of dispensing modules of a vending machine are provided. The vending machine includes a grid of mounting modules to which the dispensing modules can be removably attached. Accordingly, the arrangement of dispensing modules can be readily modified to accommodate different sized items. Some items may be placed across two dispensing modules that are operated in parallel to dispense the item. The dispensing modules may also include an indication unit. The indication unit can be used to provide assistance to servicepersons during a restocking event.

### CROSS-REFERENCE TO RELATED APPLICATIONS

This application claims the benefit of and priority to U.S. Application 63/355,427 filed on Jun. 24, 2022, the entire disclosure of which is hereby incorporated by reference.

### FIELD OF THE DISCLOSURE

The present disclosure generally relates to systems, method, and apparatuses related to a modular vending machine, and, more particularly, to control of a plurality of modular vending modules upon which items offered for sale are placed.

### BACKGROUND

Vending machines typically include a plurality of dispensing modules via which items offered for sale are placed and dispensed upon command. Conventionally, the dispensing modules are pre-configured in a fixed arrangement prior to deployment at a customer site. For example, dispensing modules are typically screwed in or otherwise fixedly attached to the base vending machine unit.

Customer demand for items offered for sale at a vending machine and the products offered for sale by vending machine operators changes over time. Thus, the particular items offered for sale at a given vending machine needs to adapt in response to these changes. However, because traditional dispensing modules are affixed to the base vending machine unit, operators of conventional vending machines are unable to rearrange and/or replace the dispensing modules over time. As a result, if there is a need for a vending machine to, for example, be stocked with additional large items, there may be insufficient slots in the pre-configured arrangement of dispensing modules. Similarly, the dispensing modules for larger items may be located in positions associated with lower customer engagement than the dispensing modules for smaller items. Thus, conventional vending machine operators are also unable to reconfigure the dispensing modules to more optimally place the dispensing modules for larger items. In view of the foregoing challenges, there is a need for a vending machine that supports a modular configuration of dispensing modules.

In some prior attempts to provide a modular arrangement of dispensing modules, dispensing modules could be modularly rearranged within a tray that holds a plurality of dispensing modules to support the weight of the individual dispensing modules. While this enables some modularity within a row of items offered for sale, the use of a tray limits the ability to offset a vertical position of the dispensing modules to account for the height of items offered for sale. To this end, even if there is an empty position in a row between two dispensing modules, the presence of the tray prevents the placement of a taller item in the row below the empty position. In other words, the need to support the weight of the individual dispensing modules and the items placed thereon still limited the ability of operators to modularly configure a vending machine. Thus there is a need for an improved dispensing module that is able to support the weight of the dispensing module and the items placed thereon to improve the modularity of the individual dispensing modules.

By improving the modularity of the dispensing modules, vending machine operators may be able to quickly reconfigure the arrangement of dispensing modules during a restocking event. However, when the configuration of the dispensing modules changes during a restocking event, there is an increased likelihood that items are restocked on the incorrect dispensing module. For example, if an item is to be placed on a newly-positioned dispensing module, the serviceperson may be inclined to mistakenly place the item on a dispensing module that already includes items of the same item type. Thus, there is also a need for systems and methods for assisted restocking of items at a vending machine.

### SUMMARY

In one embodiment, a vending machine is provided. The vending machine includes (a) a plurality of dispensing modules upon which items offered by the vending machine are placed, wherein the dispensing modules include (i) a motor configured to activate a dispensing mechanism in a forwards direction or a reverse direction, and (ii) an indication unit; (b) a planogram database configured to store a planogram indicating an arrangement of the items offered by the vending machine with respect to the plurality of dispensing modules; (c) a scanner configured to detect an identifier associated with items to be loaded into the vending machine; (d) one or more non-transitory memories configured to store a set of computer executable instructions; and (e) a controller coupled to the plurality of dispensing modules, the planogram database, the scanner, and the one or more non-transitory memories. The controller is configured to execute the set of computer executable instructions to (1) detect, via the scanner, a read event indicative of an item to be loaded, the read event indicating an item identifier; (2) query the planogram to identify a first dispensing module corresponding to the item identifier; and (3) activate the indication unit of the first dispensing module.

In another embodiment, a method of providing assisted restocking at a vending machine is provided. The vending machine includes (a) a plurality of dispensing modules upon which items offered by the vending machine are placed, wherein the dispensing modules include (i) a motor configured to activate a dispensing mechanism in a forwards direction or a reverse direction, and (ii) an indication unit; (b) a planogram database configured to store a planogram indicating an arrangement of the items offered by the vending machine with respect to the plurality of dispensing modules; (c) one or more non-transitory memories configured to store a set of computer executable instructions; and (d) a controller coupled to the plurality of dispensing modules, the planogram database, the scanner, and the one or more non-transitory memories. The method includes (1) detecting, via a scanner communicative coupled to a controller of the vending machine, a read event indicative of an item to be loaded, the read event indicating an item identifier; (2) querying, via the controller, the planogram to identify a first dispensing module corresponding to the item identifier; and (3) activating, via the controller, the indication unit of the first dispensing module.

In another embodiment, a vending machine is provided. The vending machine may include (a) a plurality of dispensing modules upon which items offered by the vending machine are placed, wherein the dispensing modules include (i) a motor configured to activate a dispensing mechanism in a forward direction or a reverse direction, and (ii) an indication unit; (b) a planogram database configured to store a planogram indicating an arrangement of a plurality of dispensing modules with respect to a plurality of mounting modules, (c) one or more non-transitory memories configured to store a set of computer executable instructions; and (d) a controller coupled to the plurality of dispensing modules, the planogram database, and the one or more non-transitory memories. The controller is configured to execute the set of computer executable instructions to (1) detect an event indicating that a previous planogram maintained at the planogram database is to be updated to a new planogram; (2) compare the previous planogram to the new planogram to identify a change in the arrangement of the plurality of dispensing modules with respect to the plurality of mounting modules; and (3) indicate, via the illumination units of the plurality of dispensing modules, the change in the arrangement of the plurality of dispensing modules with respect to the plurality of mounting modules.

### BRIEF DESCRIPTION OF THE FIGURES

FIG. 1 illustrates an example vending machine in which the present techniques are implemented;

FIG. 2A is a block diagram of an example vending machine, such as the vending machine of FIG. 1;

FIG. 2B is a block diagram of an example dispensing module to be received at the vending machine of FIG. 1;

FIG. 3A is a perspective view of the vending machine of FIG. 1;

FIG. 3B is another perspective view of the vending machine of FIG. 3A, with a door and side wall removed;

FIG. 3C is a perspective view of a modular dispensing system of the vending machine of FIGS. 3A and 3B having a custom configuration of rows of dispensing modules for accommodating units of product of the vending machine;

FIG. 3D is a perspective view of the modular dispensing system of FIG. 3C having another custom configuration of rows of dispensing modules;

FIG. 3E is a front view of the modular dispensing system of FIG. 3D;

FIG. 3F is a side view of the modular dispensing system of FIG. 3E;

FIG. 3G is a perspective view of a dispensing module of the modular dispensing system of FIGS. 3C and 3D coupled to a mounting;

FIG. 3H is a side view of the dispensing module coupled to the mounting module of FIG. 3G;

FIG. 3I is a side view of the dispensing module removed from the mounting module of FIG. 3G;

FIG. 3J is a side view of the dispensing module being removably coupled to the mounting module of FIG. 3G;

FIG. 4A depicts a signal diagram for assisted restocking at the vending machine, such as the vending machine of FIGS. 1 and 2;

FIG. 4B is a flow diagram for assisted restocking implemented at a vending machine, such as the vending machine of FIGS. 1 and 2;

FIG. 5A is a block diagram of a control system for synchronously operating two dispensing modules of a vending machine, such as the vending machine of FIGS. 1 and 2;

FIG. 5B is a flow diagram for synchronous operation of two dispensing modules of a vending machine, such as the vending machine of FIGS. 1 and 2;

FIG. 6A depicts a gantry positioned that avoids obscuring an item associated with a primary display of a vending machine, such as the example vending machine of FIGS. 1 and 2; and

FIG. 6B depicts a gantry positioned in an “x-ray” mode obscuring an item associated with a primary display of a vending machine, such as the example vending machine of FIGS. 1 and 2.

### DETAILED DESCRIPTION

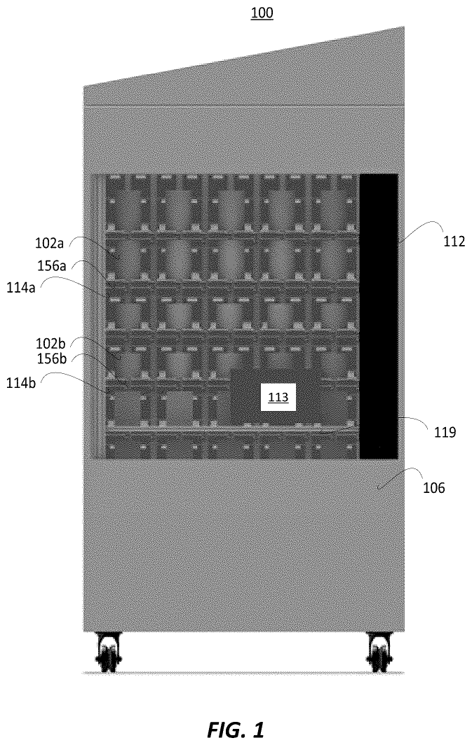

Referring to the figures in detail, FIG. 1 illustrates an example vending machine 100 in which the present techniques are implemented. The vending machine 100 may be a self-service unit that combines electro-mechanical dispensing components, temperature control components, network connectivity, and a user interface for customer interaction. The vending machine 100 may include any suitable type of vending machine 100. For example, the vending machines 100 may include a storage system for holding individual items 102 for purchase. In one example, the storage system includes a modular dispensing system, as explained more below. More particularly, the modular dispensing system may include a plurality of dispensing modules 114 in which the individual items 102 are loaded. The dispensing modules 114 may be substantially horizontal, such as embodiments that include a conveyor belt, shelf, or coil. Additionally, the dispensing modules 114 may include an indicator unit 156 (e.g., a light emitting diode (LED) or a display unit). In the illustrated example, the vending machine 100 includes a gantry 119 to receive the items 102 dispensed by the dispensing module 114 and carry the received items 102 to a dispensing slot 106. The customer may then take the items 102 from the dispensing slot 106.

The vending machine 100 may also include an atmospheric control system that includes a variety of sensors and controllers for temperature, air composition, and/or humidity control. The temperature control components may include a cooling or refrigerating apparatus, a heating or warming apparatus, and/or other temperature control apparatuses to maintain a desired temperature associated with the items stored therein. For example, some fresh foods are best stored between 35-40° F. (1.66-4.44° C.). In some embodiments, the vending machine 100 include different temperature control apparatus to regulate the temperature of different slots. A temperature control apparatus may include one or more sensors to provide feedback to a regulator of the temperature control apparatus.

The vending machine 100 may also include a point of sale system. In some embodiments, the point of sale system includes one or more mechanisms to receive a customer selection of a particular item 102. For example, the selection mechanisms may include one or more buttons and/or touchscreen displays. In the illustrated example, the vending machine 100 includes a stationary primary display unit 112 and a secondary display unit 113 mounted to the gantry 119. The vending machine 100 may control both the position of the gantry 119 and the content displayed via the secondary display unit 113 to assist the customer selection of the items 102. For example, if the customer selects an indication of a particular item 102 via the primary display unit 112, the vending machine 100 may position the gantry 119 proximate to the dispensing module 114 in which the item 102 is loaded. To this end, the vending machine 100 may position the gantry 119 above, below, to the side, or even in front of the particular item 102. If the customer does complete a purchase for particular item 102, the gantry 119 is already positioned proximate to the corresponding dispensing module 114, reducing the overall amount of time required to vend the particular item 102.

In some embodiments, the inventory control system of the vending machine 100 is configured to dynamically monitor inventory within the particular vending machine 100. In one example, the inventory control system of the vending machine 100 synchronizes inventory data with the management server 125 to maintain a central record of the inventory. In this example, the inventory update may include a sale record associated with the change in inventory. When an item is purchased, the inventory control system detects corresponding sensor data that indicates that the item is no longer within the vending machine 100. According to aspects, the transaction data may also include customer data such as demographic data, customer profile information, addressing information (including an identity and/or address of a customer electronic device), and so on.

Additionally, the inventory control system of the vending machine 100 may include a planogram that indicates the arrangement of the dispensing modules 114 and their correspondence to the items 102. As will be explained in more detail below, the vending machine 100 may include a grid of mounting modules configured to removably receive the dispensing modules 114. Accordingly, the planogram may indicate a correspondence between the dispensing modules 114 with the mounting modules. In some arrangements, the planogram may indicate that a particular mounting module is not to receive a dispensing module 114 (e.g., when the planogram indicates that a mounting module immediately below the particular mounting module is to receive a dispensing module 114). Additionally, the planogram indicates which items 102 are to be loaded into the dispensing modules 114. For example, the planogram may indicate that the item 102a is to be loaded into the dispensing module 114a and the item 102b is to be loaded into the dispensing module 114b. For items 102 that are particularly wide, the planogram may indicate that the item 102 is to be loaded across multiple dispensing modules 114.

The vending machine 100 may be in communication with a management server (not depicted) via one or more communication networks. The communication networks may facilitate any type of data communication via any current or future-developed standard or technology (e.g., GSM, CDMA, TDMA, WCDMA, NR, LTE, EDGE, OFDM, GPRS, EV-DO, UWB, IEEE 802 including Ethernet and Wi-Fi, WiMAX, Bluetooth, RS-232 serial communications, and others). The vending machine 100 may be configured to receive planogram update indications from the management server via the communication networks. The planogram update may indicate a new planogram for the vending machine 100. Accordingly, a serviceperson may be instructed to rearrange the dispensing modules 114 and/or the items 102 to comply with the new planogram indicated by the planogram update. This process will be described in more detail below.

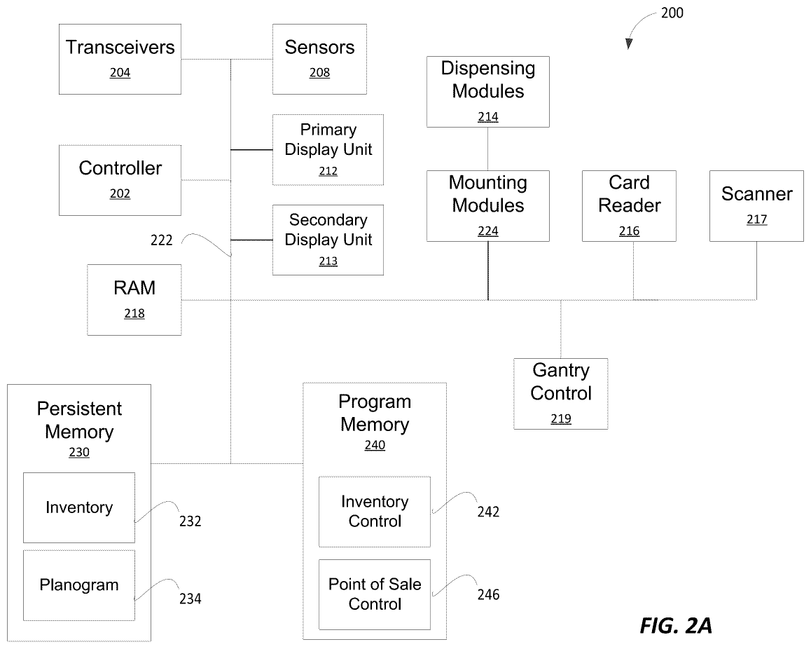

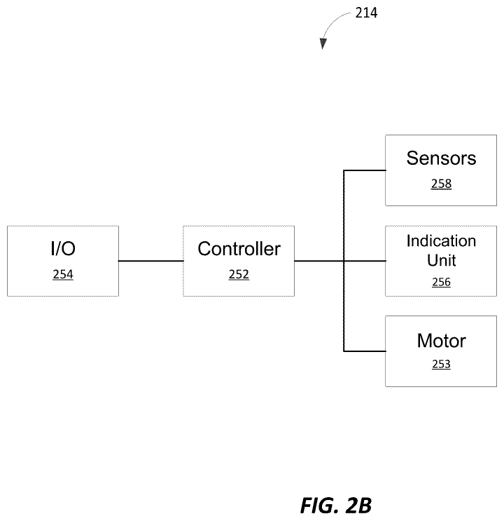

Turning to FIG. 2A, illustrated is an example vending machine 200, such as the vending machine 100 of FIG. 1, at which functionality described herein is implemented. The vending machine 200 may include transceivers 204 that enable the vending machine 200 to exchange data over a wireless or wired network with, for example, a management server. The transceivers 204 may include one or more transceivers (e.g., WWAN, WLAN, WPAN, EVDO, CDMA, GSM and/or LTE transceivers) functioning in accordance with IEEE standards, 3GPP standards, or other standards.

The vending machine 200 includes a controller 202 that includes one or more processors and/or controllers, such as a central processing unit (CPU) 202, a graphics processing unit (GPU), a programmable logic controller (PLC), a proportional-integral-derivative (PID) controller, etc. During operation, the controller 202 executes instructions stored in a program memory module 240 coupled to the controller 202 via a system bus 222. In some implementations, the program memory module 240 is implemented in a random access memory (RAM) module 218, a persistent memory module 230, or both. The program memory module 240 may also store computer-readable instructions that regulate the operation of the vending machine 200. Accordingly, the controller 202 (in coordination with the controllers 252 of the dispensing modules 214) may be configured to execute one or more of the flowcharts described herein.

As illustrated, the vending machine 200 also includes mounting modules 224 configured to removably receive dispensing modules 214 (such as the dispensing modules 114 as described with respect to FIG. 1). With simultaneous reference to FIG. 2B, illustrated is an example dispensing module 214. It should be appreciated that the vending machine 200 may include any number of dispensing modules 214 configured in the manner described with respect to FIG. 2B.

The dispensing modules 214 includes a controller 252 configured to control operation of the dispensing module 214. The controller 252 may include a processor such as, for example, one or more microprocessors, controllers, and/or any suitable type of processor and a memory storing instructions that are executed by the processors to perform the functionality of the dispensing module 214 described herein. The controller 252 is communicatively coupled to the controller 202 of the vending machine 200 via an I/O interface 254. The I/O interface 254 may include one or more transceivers configured in accordance with a communication protocol for communications between the dispensing modules 214 and the vending machine 200. As will be described in more detail below, the communication link between the controller 252 and the controller 202 may be completed when the dispensing module 214 is securely received into a mounting module 224.

The dispensing module 214 includes a motor 253 that drives a dispensing mechanism of the dispensing module 214. For example, the motor 253 may be configured to drive a conveyor belt, a coil, a plunger, or any other dispensing mechanism known in the art. The motor 253 may be able to operate in both a forward mode to move an item loaded into the dispensing module 214 toward the front of the vending machine 200 and a reverse mode to move an item loaded into the dispensing module 214 towards the rear of the vending machine. In some embodiments, the motor 253 includes its own controller configured to interpret instructions received from the controller 252. For example, instead of merely operating in a forward or reverse mode, the motor 253 may be controlled to provide different power outputs resulting in a different rate of motion exhibited by the dispensing mechanism. As will be described in more detail below, some items may be placed across two or more dispensing modules 214. Accordingly, the controller 252 may adjust the power output of the motor 253 to maintain a synchronous dispensing motion with the other dispensing modules 214.

The example dispensing unit 214 includes one or more sensors 258 to sense various conditions associated with the dispensing module. For example, the sensors 258 may include one or more sensors configured to detect when an item has been loaded into the front of the dispensing module 214. In this example, the sensors 258 may include a weight sensor disposed in a front end of the dispensing module 214 or a pressure sensor proximate to a weight-bearing mechanism at the base of the dispensing module 214. As another example, the sensors 258 may include one or more sensors configured to monitor operation of the motor 253 and/or the dispensing mechanism controlled by the motor 253. As yet other examples, the sensors 258 may include a beam break sensor having a beam oriented towards positions on the dispensing module 214 or an image sensor configured to capture image data of a code (e.g., bar code or QR code) disposed on an item placed on the dispensing unit 214. In some embodiments, the beam break sensors and/or the image sensor are configured to monitor multiple dispensing units and are included in the vending machine 200 in positions external to the dispensing module 214.

As illustrated, the dispensing module 214 includes an indication unit 256, such as one or more light emitting diodes (LEDs), a display screen, or other types of configurable output devices. The controller 252 may be configured to interface with the indication unit 256 to provide indications to individuals interacting with the vending machine 200. For example, when a serviceperson is restocking the vending machine 200, the controller 252 may configure the indication unit to provide a first response to indicate that an item is to be loaded into the dispensing module 214 (e.g., illuminate the LEDs in a green color). As another example, if the serviceperson incorrectly loaded an item into the dispensing module 214, the controller 252 may configure the indication unit to provide a second response to indicate the incorrect action (e.g., illuminating the LEDs in a red color and/or causing the LEDs to blink).

In operation, the controller 252 is configured to receive instructions for controlling the motor 253 and/or the indication unit 256 from the controller 202 via the I/O 254. For example, the application being executed by the controller 202 may instruct the controller 252 to control operation of the 253 in a particular manner. In response, the controller 252 may transmit an acknowledgement message back to the controller 202 via the I/O 254. The controller 252 may also be configured to transmit reports based on sensor data generated by the sensors 258 to the controller 202. For example, controller 252 may be configured to detect that the sensors 258 indicate that an item was loaded into the dispensing module 214 and transmit a report to the controller 202 for analysis thereat.

Returning to FIG. 2A, one set of instructions stored in the memory 240 may be an inventory control application 242 that contains instructions to facilitate inventory control functionality. For example, the inventory control application 242 may maintain an accurate record of the various items stored at the vending machine 200. This record may be maintained at the inventory database 232 of the persistent memory 230. The records in the inventory database 232 may include indications of an item identifier, a stock keeping unit (SKU) identifier, a location (such as a dispensing module identifier), expiration data, an item status (e.g., available, reserved, expired, locked, sold, etc.), and so on. In some embodiments, the inventory database 232 also includes SKU-based records that include indications of SKU quantity, a cost, SKU status (e.g., normal, recalled, promoted, stocked out, etc.). The SKU-based records may be automatically updated in response to changes to item records. For example, when the inventory control application 242 updates an item record to indicate that a particular item has been sold and/or reserved, the SKU-record may automatically decrement a quantity parameter.

The inventory control application 242 may also be configured to store and/or update a planogram 234 that indicates an arrangement of dispenser modules 214 with respect to a plurality of mounting modules 224 and an arrangement of items (such as the items 102 as described with respect to FIG. 1) with respect to the dispensing modules 214. In one implementation, the planogram 234 includes a grid of mounting objects that reflects the arrangement of the mounting modules 224. Mounting objects in the planogram 234 may correspond to a dispensing object that indicates a type of dispensing module 214. Similarly, dispensing objects in the planogram 234 may correspond to item objects that indicate an item type for items to be loaded into the corresponding dispensing module 214.

As illustrated, applications in the program memory 240 are configured to communicate with a particular dispensing module 214 via the particular mounting module 224 at which the particular dispensing module 214 is received. Accordingly, the inventory control application 242 may update the planogram 234 with information related to the correspondence between the mounting modules 224 and the dispensing modules 214. In one example technique to determine the correspondence, the mounting modules 224 are configured with circuitry that completes a circuit when a dispensing module 214 is properly received thereat. In response, the mounting module 224 may indicate to the inventory control program 242 that a dispensing module 214 has been received thereat. The inventory control application 242 reply to the mounting module 224 with a “wake up” instruction configured to cause the controller 252 of the dispensing module 214 received thereat to respond with identity information (e.g., a dispenser type, a dispenser identifier, etc.). The inventory control application 242 may then update the dispenser object corresponding to the mounting module 224 in the planogram 234 to include the received identity information.

The inventory control application 242 may reference the identity information in the planogram 234 to control the corresponding dispensing module 214. For example, the inventory control application 242 may be configured to actuate the motor 253 of the dispensing module 214 in a forward direction to unload an item (e.g., in response to a customer purchase or to unload the dispensing module 214 during a restocking event). As another example, the inventory control application 242 may be configured to actuate the motor 253 in a reverse direction to move a restocked item further back into the vending machine 200 such that another item can be loaded into the front of the dispensing module 214.

In some embodiments, each mounting module 224 is connected to the system bus 222. In these embodiments, to control a particular dispensing module 214, the controller 202 addresses the control instruction to the particular mounting module 224 which relays the control instruction on to the controller 252 of the particular dispensing module 214. Additionally or alternatively, the mounting modules 224 may be connected to a dispensing module control bus (not depicted) connected to the system bus 222. In these embodiments, the I/O 254 of the dispensing modules 214 are connected to the dispensing module control bus. Accordingly, the controllers 252 of the dispensing modules 214 may monitor the dispensing module control bus for control instructions addressed thereto. Accordingly, in these embodiments, the controller 202 includes an identifier of the dispensing module 214 that is to execute the control instruction and routes the control instruction to the dispensing module control bus.

As illustrated, the example vending machine 200 includes a scanner 217 to scan identifying information associated with items loaded into the vending machine 200. The scanner 217 may be a barcode scanner, a radio frequency identification (RFID) scanner, a near field communication (NFC) scanner, or other type scanner capable of scanning identifying information associated with items. In some embodiments, the scanner 217 is affixed to a housing of the vending machine 200. In other embodiments, the scanner 217 may be a handheld scanner (e.g., a dedicated handheld barcode scanner, user equipment associated with the serviceperson, etc.) coupled to the vending machine 200. Accordingly, while FIG. 2A depicts the scanner 217 as being coupled to the system bus 222, in some embodiments, the scanner 217 is wirelessly coupled to the vending machine 200 via the transceivers 204.

The scanner 217 enables the inventory control application 242 to provide assisted restocking guidance to a serviceperson restocking the vending machine 214. To this end, prior to restocking an item, the serviceperson is instructed to scan the item via the scanner 217. The inventory control application 242 is configured to detect the item identifier associated with the item to determine an item type for the item. Using the determined item type, the inventory control application 246 queries the planogram 234 to identify a dispensing module 214 in which the item is to be loaded. If there are multiple dispensing modules 214 associated with the item type, the inventory control application 242 may alternate between the dispensing modules 214. Upon identifying the dispensing module 214 in which the item is to be loaded, the inventory control application 242 may instruct the dispensing module 214 to enable the indication unit 256 in a manner the indicates the item is to be loaded into that dispensing module.

The program memory 240 may also include a set of instructions that comprises a point of sale control application 246 configured to support the ordering of items and the processing of payments at the vending machine 200. The point of sale control application 246 may be configured to cause a primary display unit 212 and the secondary display unit 213 to present one or more interfaces that guide a customer through the purchase process. The primary display unit 212 may include a touch-screen display for receiving user input. In some embodiments, the point of sale control application 246 may query the inventory database 236 to populate the interfaces with indications of the available inventory. As part of the payment process, the point of sale control application 246 monitors inputs at a card reader 216 to detect credit card information for completing the purchase.

As part of guiding the customer through the purchase process, the point of sale control application 246 may determine that the customer is viewing a user interface associated with a particular item type offered for sale. In response, the point of sale control application 246 may query the planogram 234 to identify a dispensing module 214 in which items of the particular item type is loaded. To reduce waste, if multiple dispensing modules 214 include items of the particular item type, the point of sale control application 246 may identify the dispensing module 214 with the oldest not-expired item of the particular item type at the front most position. After identifying the dispensing module 214, the point of sale control application 246 may instruct the gantry control 219 to move to a position proximate to the dispensing module 214. Additionally, the point of sale control application 246 may configure the secondary display unit 213 to display additional information regarding items of the particular item type.

As described elsewhere herein, some items are loaded across two dispensing modules 214. Accordingly, in response to detecting a customer purchase of one of these items, the point of sale control application 246 may generate an instruction to simultaneously activate the motors 253 of both dispensing modules 214. It should be appreciated that due to item placement and/or differing amount of wear and tear, the dispensing mechanisms of each dispensing module 214 may move at different rates in response to their controllers 252 controlling their respective motors 253 to output the same power. If the dispensing mechanism is a conveyor belt, this may result in the product spinning or even falling off of the dispensing modules 214. Accordingly, the point of sale control application 246 may route data from the sensors 258 of the dispensing modules 214 to a PLC or a PID controller of the controller 202 that implements closed-loop control techniques that automatically scale the power output of one of the motors 253 to ensure that the respective dispensing mechanisms move at the same rate.

It should be appreciated that while the foregoing sets out a description of the inventory control application 242 and the point of sale control application 246, in other embodiments, the functionality described with respect to the inventory control application 242 and the point of sale control application 246 may be divided and/or combined into any number of applications stored in the program memory 240.

In addition to the program memory 240, the RAM module 218 and the persistent memory module 230 may store data in a volatile or non-volatile mode, respectively. The RAM module 218 and the persistent memory module 230 further include one or more forms of fixed and/or removable memory, such as read-only memory (ROM), electronic programmable read-only memory (EPROM), RAM, erasable electronic programmable read-only memory (EEPROM), and/or other hard drives, flash memory, MicroSD cards, and others. For example, the inventory database 232 and the planogram 234 may be stored as data structures in the persistent memory module 230.

It should be appreciated that the vending machine 200 may include additional or fewer components than what is depicted by FIG. 2. For example, the vending machine 200 may include keys, mice, buttons, or other physical input devices to facilitate user interactions with the vending machine 200. As another example, the vending machine 200 may include one or more external ports or other components that enable service personnel to interact with the vending machine 200, such as a USB or other port via which a service electronic device can be connected to transmit diagnostic messages for troubleshooting and/or maintenance activities. As yet another example, the vending machine 200 may include one or more cameras, scanners, or other sensors connected to track the items stored at the vending machine 200 and/or to support security surveillance, stock monitoring, scanning customer electronic devices, customer biometric recognition, and/or gesture-based reservation pickup, for example.

### Modular Dispensing System and Modules

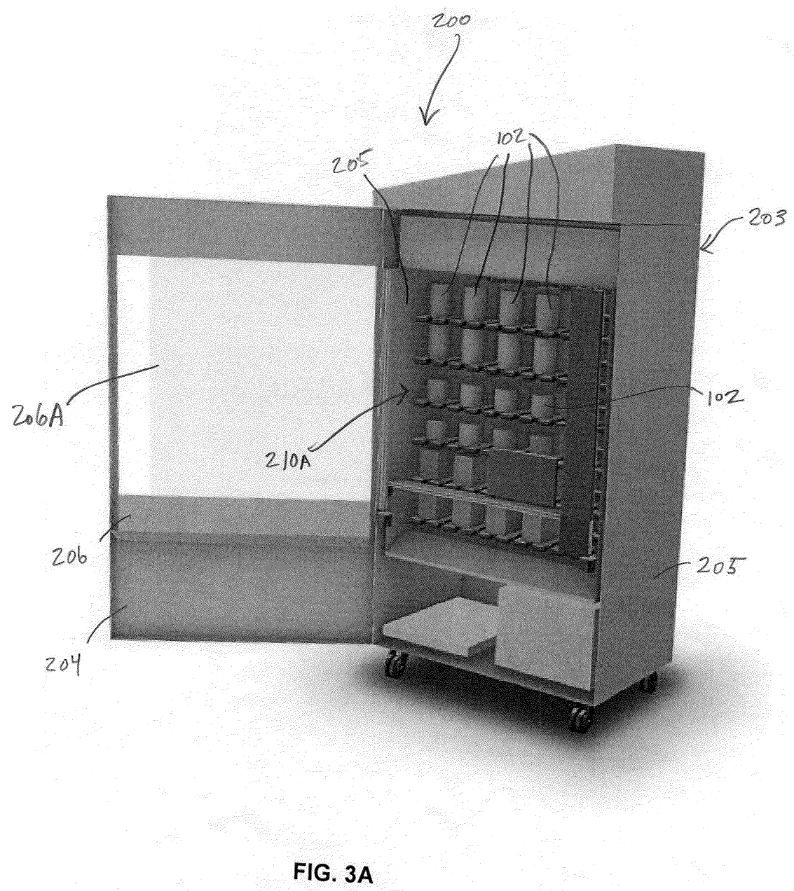

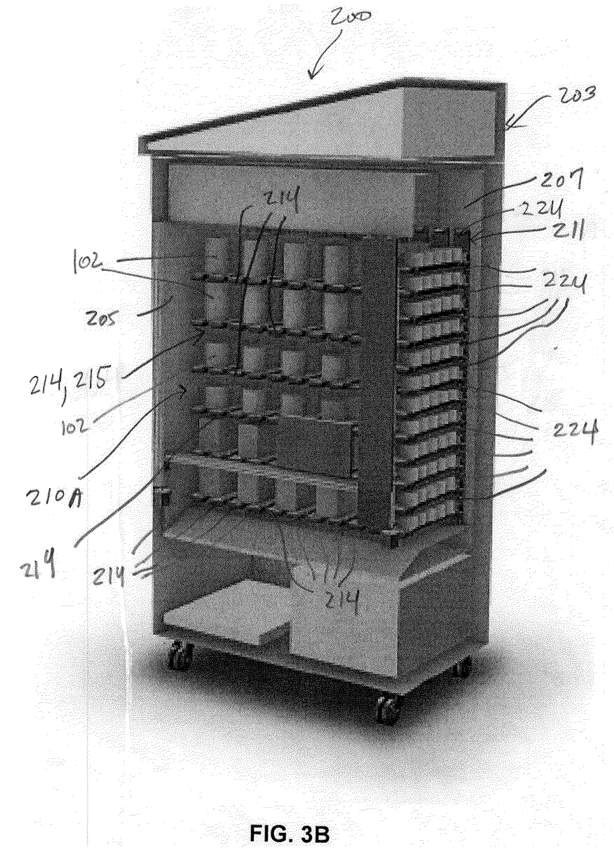

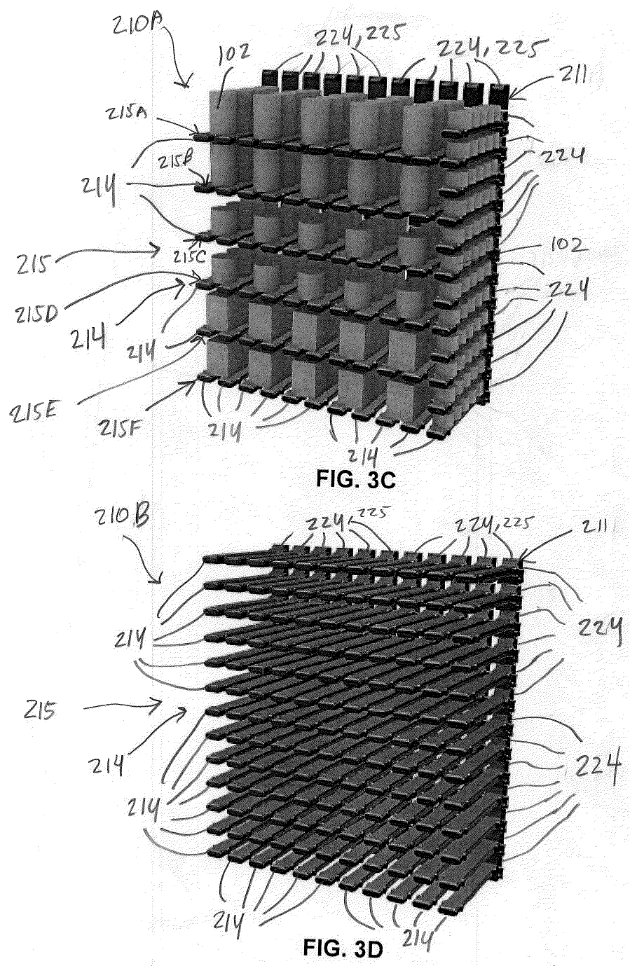

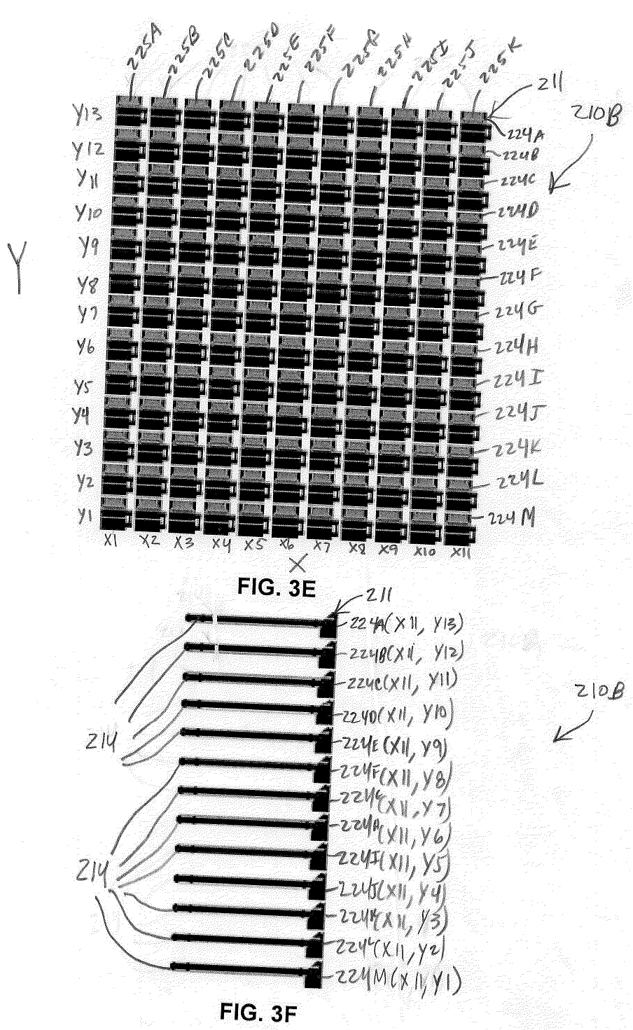

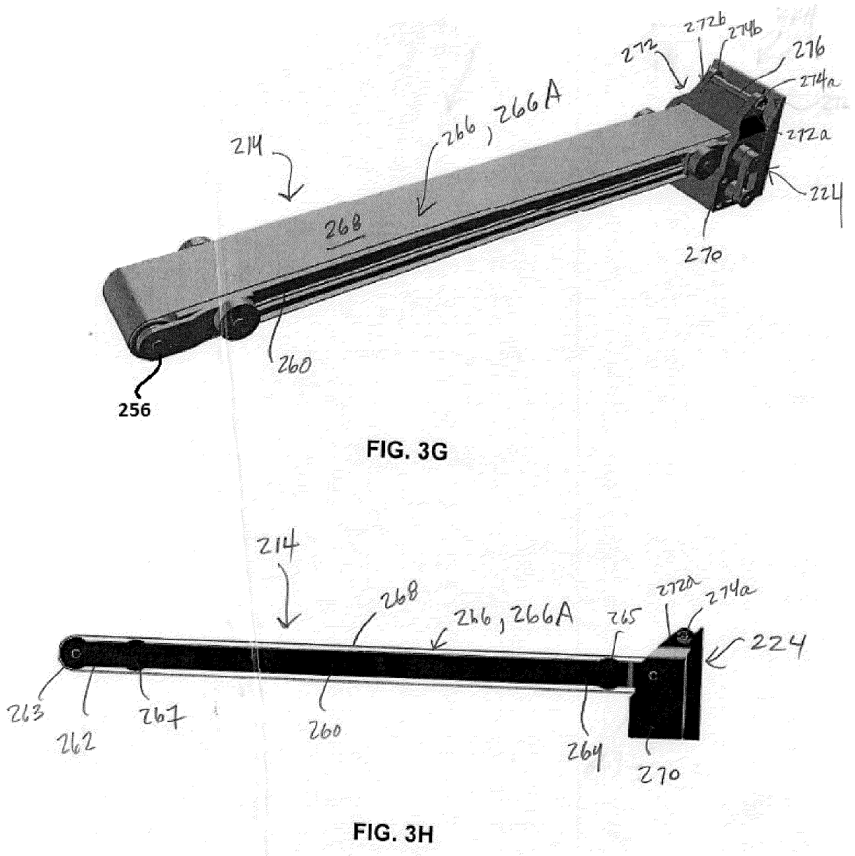

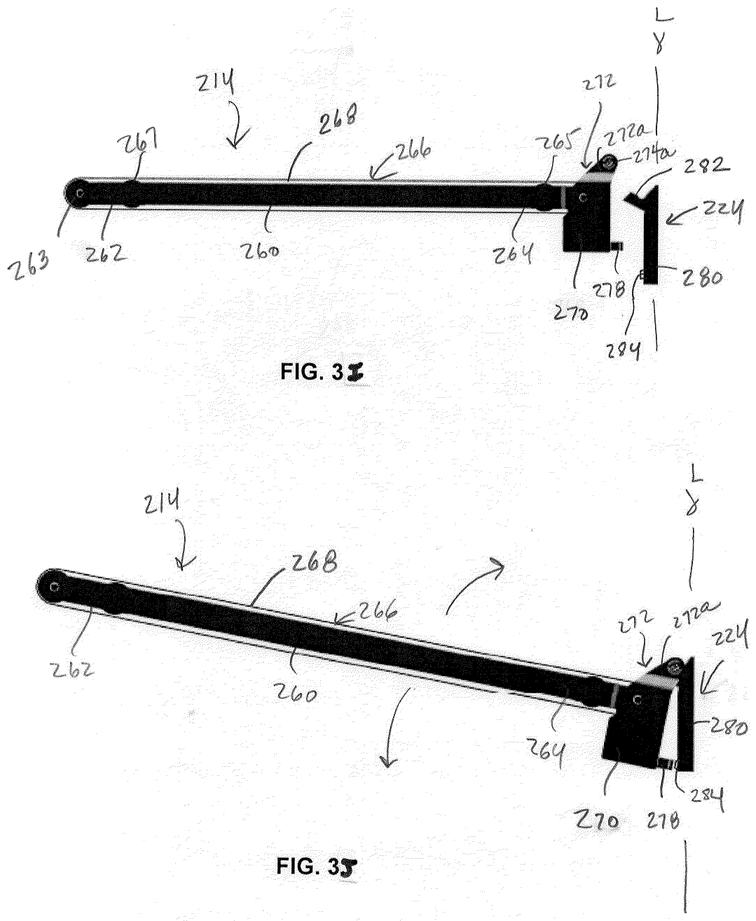

Referring now to FIGS. 3A-3B a vending machine 200 referenced in FIG. 2A is depicted and includes many of the same features as the vending machine 100 of FIG. 1. As a result, parts of the vending machine 200 that are the same as parts of the vending machine 100 include the same reference numbers increased by 100 and are not explained again in detail for the sake of brevity.

More specifically, and referring specifically to FIG. 3A, the vending machine 200 includes a housing 203 having a door 204 and a pair of side walls 205. The door 204 is disposed on a front area of the housing 203 and is in an open position in the configuration of the vending machine 200 provided in FIG. 3A. The door 204 includes a dispensing slot 206 from which the customer may take one or more items 102 and a transparent portion 206A through which the customer can view items 102 disposed within the housing 203 of the vending machine 200 when the door is in a closed position, for example (see, e.g., FIG. 1). The vending machine 200 further includes a modular dispensing system 210A, such as bidirectional modular dispensing system, disposed within the housing 203, as explained more below.

Referring now to FIG. 3B, the vending machine 200 of FIG. 3A is depicted with the door 206 and one of the side walls 205 removed, such that the modular dispensing system 210A disposed within the housing 203 of the vending machine is more visible. The housing 203 further includes a rear wall 207 to which at least a portion of the modular dispensing system 210A is attached. More specifically, the modular dispensing system 210A includes a grid 211 of mounting modules 224 secured to the rear wall 207 of the housing 203, and each mounting module 224 has an X/Y position on the grid 211, as explained more below. The modular dispensing system 210A further includes a plurality of dispensing modules 214 removably coupled to the mounting modules 224 of the grid 211 and capable of being arranged in a plurality of rows 215 within the housing 203. At least one dispensing module 214 is configured to receive the item 102 for purchase. In this example, the plurality of rows 215 includes six rows of dispensing modules 214 for receiving the items 102, with the first row of the dispensing modules 214 being the lowermost row of dispensing modules 214. Five additional rows of dispensing modules 214 are disposed above the first row, as depicted in FIG. 3B. While FIG. 3B depicts this example configuration of the dispensing modules 214, it will be appreciated that the modular dispensing system 210A of the present invention may include various other arrangements of dispensing modules 214 coupled to the mounting modules 224, such that more or fewer rows of the plurality of rows 215 may be arranged within the housing 203.

More specifically, each dispensing module 214 of the plurality of dispensing modules 214 is configured to be coupled to any one of the mounting modules 224 of the grid 211 at any particular X/Y position on the grid 211 of mounting modules 224. In this way, the modular dispensing system 210A may accommodate one or more various heights and widths of the items 102 for purchase to be disposed on one or more dispensing modules 214.

Referring now to FIG. 3C, the modular dispensing system 210A of FIG. 3B only disposed outside of the housing 203 of the vending machine 200 is depicted. The grid 211 of the mounting modules 224 includes a plurality of columns 225, and each column 225 includes a plurality of mounting modules 224. In addition, each mounting module 224 in each column includes a different X/Y position on the grid 211, as explained more below relative to FIG. 3E, for example. In this example, the plurality of columns 225 includes eleven vertical columns with each column 225 including thirteen mounting modules 224. It will be appreciated that the grid 211 of mounting modules 224 may include more or fewer columns having more or fewer mounting modules 224 in each column, depending upon the size of the housing 203 of the vending machine 200, for example, and still fall within the scope of the present disclosure.

As further depicted in FIG. 3C, the plurality of dispensing modules 214 are removably coupled to the mounting modules 224 to form the plurality of rows 215 of dispensing modules 214. Generally, at least one row of the plurality of rows 215 may be formed across at least a portion of the columns 225, as depicted in FIG. 3C, and the dispensing modules 214 may be coupled to only some of mounting modules 224 of the grid 211 to accommodate various items 102 for purchase.

More specifically, and in this example of FIG. 3C, the plurality of rows 215 of dispensing modules 214 includes six rows 215A-215F across ten columns 225 of the plurality of columns 225. In addition, there are twelve dispensing modules 214 coupled to mounting modules 224 in one column 225, which is a rightmost column 225 of the modular dispensing system 210A. Further, a first row 215A of dispensing modules 214 includes dispensing modules 214 coupled to the third mounting module 224 for each of ten columns 225, a second row 215B includes dispensing modules coupled to the fifth mounting module 224 for each of the same ten columns 225, and a third row 215C includes dispensing modules 214 coupled to the seventh mounting module 224 for each of the same ten columns 225. In a similar manner, a fourth row 215D includes dispensing modules 214 coupled to the ninth mounting module 224 for each of the same ten columns 225, a fifth row 215E includes dispensing modules 214 coupled to the eleventh mounting module 224 for each of the same ten columns 225, and a sixth row 215F includes dispensing modules 214 coupled to the thirteenth module 224 again for each of the same ten columns 225. So configured, the height between each of the rows 215A-215F of the plurality of rows 215 of the dispensing modules 214 is the same for ten of the eleven columns 225 of mounting modules 224 of the grid 211. Further, for the rightmost column 225 of mounting modules 224, the dispensing modules 214 are coupled to twelve of the thirteen mounting modules 224 in this column 225 of mounting modules, forming a height between each dispensing module 114 that is less than the height between the plurality of rows 215 having six rows of dispensing modules 214. So configured, the rightmost column 225 having the greater number of dispensing modules 214 coupled to the mounting modules 224 accommodates items 102 having a smaller size, such as a smaller height and width, than the columns 225 having a fewer number of dispensing modules 214 coupled to the mounting modules 224 in a given column 225.

More generally, the distance between each row of the plurality of rows 215 of the dispensing modules 214 is capable of being adjusted, e.g., depending upon the particular X/Y position of the mounting module 224 to which the dispensing module 214 is coupled, to one or more of: (1) the same between each row; (2) increasingly greater between each row; (3) increasingly smaller between each row; and/or (4) different between at least two rows of the plurality of rows 215 of dispensing modules 214 to accommodate one or more heights of items 102 for purchase.

As also depicted in FIG. 3C, the items 102 disposed in each row 215A-215F are disposed on multiple dispensing modules 214, such as two dispensing modules 214 in this example, as clearly depicted in the lowermost row 215F of dispensing modules 214, for example. In this example, the vending machine 200 recognizes that the item 102 is disposed on two dispensing modules 214, identifies the X/Y position on the grid 211 for the dispensing modules 214, and synchronizes the operation of these dispensing modules 214 accordingly when a command or instruction to vend the item 102 disposed on the pair of dispensing modules 214 is received. While the multiple dispensing modules 214 on which the item 102 is disposed in FIG. 3C includes two dispensing modules 214, it will be understood that the multiple dispensing modules 214 may alternatively include three or more dispensing modules 214 and still fall within the scope of the present disclosure.

It will be appreciated that the flexible characteristics of the modular dispensing system 210A of the present disclosure allow the dispensing modules 214 to be coupled to any desired number of mounting modules 224 disposed at desired X/Y positions on the grid 211 to accommodate different heights and widths of units 102 disposed on the dispensing modules 214. Units for purchase 102 having a greater width than other units for purchase 102 may be disposed on two dispensing modules 214, and units 102 for purchase having a smaller width may be disposed on one dispensing module 214, as again depicted in FIG. 3C.

Referring now to FIG. 3D, another exemplary modular dispensing system 210B of the present disclosure is depicted. The modular dispensing system 210B includes essentially all of the same features as the modular dispensing system 210A of FIGS. 3A-3C, except in this example the dispensing modules 214 of the plurality of dispensing modules 215 are coupled to each mounting module 224 of the mounting modules 224 of the grid 211. In this way, many items 102 for purchase may be disposed on the various dispensing modules 214, and a distance, such as a height distance, between each dispensing module 214 is the same.

Referring now to FIGS. 3E and 3F, the grid 311 of the modular dispensing system 210B of FIG. 3D is depicted with a dispensing module 214 coupled to each mounting module 224, as best depicted in the rightmost column 225 of the mounting modules of the grid 211. More specifically, the grid 211 of the modular dispensing system 210B, which is the same grid 211 of the modular dispensing system 210A, includes an X axis having a plurality of X coordinates corresponding to a number of mounting modules 224. The grid 211 also includes a Y axis having a plurality of Y coordinates corresponding to a number of mounting modules. In this example, the plurality of X coordinates includes X coordinates X1-X11, and the plurality of Y coordinates includes coordinates Y1-Y13. As will be appreciated, there may be fewer or more X coordinates and Y coordinates on the grid 211 and still fall within the scope of the present disclosure. Based on this X/Y coordinate system, each mounting module 224 of the grid 211 includes an X/Y position on the grid 211 corresponding to the X coordinates and the Y coordinates, as explained more below.

As also depicted in FIG. 3E, the modular dispensing system 210B includes columns 225A-225K of mounting modules 224, and the mounting modules 224 include mounting modules 224A-224M in each column 225A-225K. The mounting modules 224A-224M are identified for column 225K in FIG. 3E, and it will be understood that each of columns 225A-225J also includes mounting modules 224A-224M vertically disposed in each column 224A-224M, as further depicted in FIG. 3E.

Referring now to FIG. 3F, a side view of the modular dispensing system 210B is depicted, and the X/Y position on the grid 211 for each mounting module 224A-224M is depicted as well adjacent to each mounting module 224A-224M. Specifically, it will be understood from the X/Y coordinate system of the grid 211 depicted in FIG. 3E, that the mounting module 224A has the X/Y position of X11, Y13, and the mounting module 224B has the X/Y position of X11, Y12. In fact, all of the mounting modules 224A-224M disposed in column 225K have an X position of X11. In addition, the mounting modules 224C-224M have a Y position of Y11-Y1, respectively, as also depicted in FIG. 3F. When the dispensing modules 214 are coupled to the mounting modules 224A-224M, the controller 252 (FIG. 2B) of each dispensing module 214 provides a communication link with the controller 202 (FIG. 2A) of the vending machine 200. This enables the controller 252 to identify the X/Y position of each dispensing module 214 based on the X/Y positions of the mounting modules 224 on the grid 211 to which the dispensing modules 214 are coupled.

Referring now to FIGS. 3G and 3H, a single dispensing module 214 is depicted and coupled to a single mounting module 224, which is representative of each dispensing module 214 and mounting module 224 referred to herein. Specifically, each dispensing module 214 of the plurality of dispensing modules 215 includes a body 260 having a first end 262 and a second end 264, a dispensing mechanism 266 disposed between the first and second ends 262, 264 for moving the item 102 for purchase from a first position on the dispensing mechanism 266 near the second end 264 of the body 260 to a second position at or near the first end 262 of the body 260 to discharge the item 102 from the dispensing module 214, for example. In one example, and as depicted in FIGS. 3G and 3H, the dispensing mechanism 266 is a conveyor system 266A having first rollers 263, 267 disposed at or near the first end 262 of the body 260, a second roller 265 disposed at or near the second end 264 of the body 260, and a conveyor belt 268 disposed around the first and second rollers 263, 265, 267 on either side of the body 260. In some embodiments, the conveyor belt 268 is further disposed around an additional second roller (not depicted) disposed in a shoulder 270. The conveyor belt 268 is configured to move around the rollers 263, 265, 267 in a first direction or a second direction. In one example, the first direction is a direction toward the first end 262 of the body, and the second direction is a direction toward the second end 264 of the body 260.

As further depicted in FIGS. 3G and 3H, the dispensing module 214 includes an indication unit 256 disposed near the first end 262 of the body 260. In the depicted embodiment, the indication unit 256 includes a light emitting diode (LED) disposed within a housing that supports the first roller 263. The housing includes an aperture via which the light emitted by the LED passes through to illuminate a region proximate to the first end 262. Alternatively, the LED may be disposed in other portions of the body 260 near the first end 262. While FIG. 3G depicts a single LED position on a near side of the first end 262 of the body 260, in some embodiments, the indication unit 256 includes an additional LED on an opposite side of the first end 262. In alternate embodiments, the indication unit 256 includes a display screen affixed to a member extending from the first end 262 of the body 260.

As further depicted in FIGS. 3G and 3H, the dispensing module 214 further includes a shoulder 270 disposed near or at the second end 264 of the body 260. The shoulder 270 includes a pair of projections 272 with a first projection 272a and a second projection 272b, and each of the first and second projections 272a, 272b includes an aperture 274a, 274b, respectively. A cylindrical member 276 includes a first end 276a disposed in one aperture 274a of one projection, such as the first projection 272a of the pair of projections 272, and a second end 276b disposed in the other aperture 274b of the other projection, such as the second projection 272b. In one example, the cylindrical member 276 is a portion of the dispensing module 214 that is configured to contact another portion of the mounting module 224 when the dispensing module 214 is coupled to the mounting module 224. Alternatively, the portion of the dispensing module 214 may take a form and/or shape different from the example cylindrical member capable of coupling to the mounting module 224 and still fall within the scope of the present disclosure.

Referring now to FIGS. 31 and 3J, the shoulder 270 further includes a post 278 outwardly extending from, such as away from, the second end 264 of the body 260 at an end of the shoulder 270 opposite to the pair of projections 272. The post 278 is configured to be plugged into a portion of the mounting module 224 when the dispensing module 214 is coupled to the mounting module 224, as explained more below. In addition, the mounting module 224 224 includes a body 280 having a longitudinal axis L, an extending portion 282, such as a hook, and a port 284 configured to receive the post 278 of the shoulder 270 of the dispensing module 214 when the dispensing module 214 is coupled to the mounting module 224. The body 260 of the dispensing module 214 is rotatably coupled to the body 280 of the mounting module 224 via the cylindrical member 276, which one or more of contacts and/or latches the extending portion 282, such as a hook, of the mounting module 224.

The body 260 of the dispensing module 214 is capable of rotating in counterclockwise direction relative to the longitudinal axis L of the mounting module 224 to allow the post 278 of the dispensing module 214 to be inserted into the port 284 of the mounting module 224. Likewise, the body 260 of the dispensing module 214 is also capable of rotating in a clockwise direction relative to the longitudinal axis L of the mounting module 224 when it is desired to unplug the post 278 of the dispensing module 214 from the port 284 of the mounting module 224. In addition to the mechanical connections that enable the post 278 to be inserted into the port 284, the post 278 and the port 284 further include electrical connections (not depicted) that mate when the post 278 is inserted into the port 284. Accordingly, inserting the post 278 into the port 284 establishes a communicative coupling between the controller 202 of the vending machine 200 and the controller 252 of the dispensing module 214.

According to aspects, the components housed within the shoulder 270 are disposed such that the weight is distributed as close to the body 280 of the mounting module 224 as possible. By disposing the weight in such a manner, the weight within the shoulder 270 acts a counterweight to any items 102 placed on the first end 262 of the body 260. This enables the dispensing module 214 to support the weight of the items 102 and the body 260 without the use of a load-bearing tray that supports the weight of each dispensing module 214 in a row of the plurality of rows 215.

It will be appreciated that the foregoing vending machine 200 and modular dispensing systems 210A, 210B may operate according to one or more of the following methods. Specifically, the method may include a method of coupling the dispensing module 214 of the modular dispensing system 210A, 210B for the vending machine 200 to the mounting module 224 of the modular dispensing system 210A, 210B. The method may also comprise latching a member of the body 260 of at least one dispensing module 214 to the extending portion 282 of the mounting module 224 disposed at a particular X/Y position on the grid 211 of the mounting module 224. In one example, latching the member of the body 260 of at least one dispensing module 214 to the extending portion 282 of the mounting module 224 disposed at a particular X/Y position on the grid 211 of the mounting module 224 comprises latching a cylindrical member of the body of at least one dispensing module 214 to the hook 282 of the mounting module 224 disposed at a particular X/Y position on a grid 211 of the mounting modules 224.

In addition, the method may include rotating the body 260 of the at least one dispensing module 214 in a clockwise direction relative to the longitudinal axis L of the mounting module 224. The method may still also include inserting the portion of the dispensing module 214 into the port 284 of the mounting module 224 to couple the dispensing module 214 to the mounting module 224. So configured, the body 260 of the dispensing module 214 is then disposed in an approximate horizontal position relative to the longitudinal axis L of the mounting module 224. In one example, inserting the portion of the dispensing module 214 into the port 284 of the mounting module 224 to couple the dispensing module 214 to the mounting module 224 comprises inserting the post 278 of the dispensing module 214 into the port 284 of the mounting module 224 to couple the dispensing module 214 to the mounting module 224.

The method may still also include identifying, via at least one processor of the vending machine 200, an X/Y position of the dispensing module 214 based on an X/Y position of the mounting module 224 on the grid 211 to which the portion of the dispensing module 214 is inserted.

### Assisted Restocking

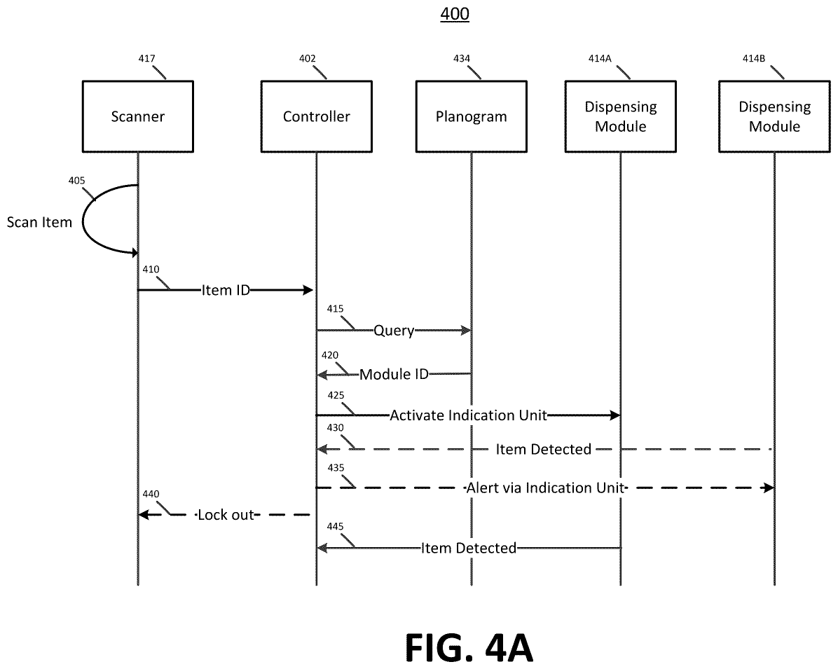

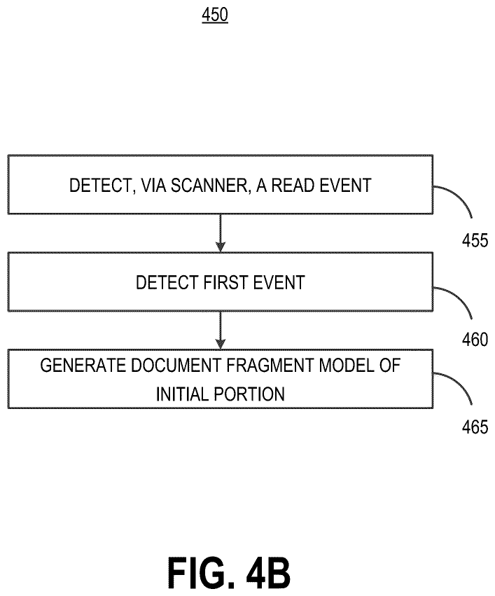

FIG. 4A depicts an example signal diagram 400 representative of actions performed by components of a vending machine (such as the vending machines 100 or 200) to implement assisted restocking techniques. More particularly, the example signal diagram illustrates the actions performed by a scanner 417 (such as the scanner 217), a controller 402 (such as the controller 202), a planogram 434 (such as the planogram 234), and dispensing modules 414A, 414B (such as dispensing modules 114, 214). It will be appreciated that the techniques described with respect to example signal diagram 400 may be performed with respect to either an item to loaded into the vending machine for a first time or an item that was previously offered by the vending machine.

The assisted restocking techniques represented by the example signal diagram 400 may be implemented during a vending machine restocking event performed by a serviceperson. Accordingly, the serviceperson may carry to the vending machine a plurality of items (such as the items 102) to be loaded into the vending machine. In some embodiments, prior to loading the vending machine, the vending machine may first unload blocking items within the dispensing modules 414. This enables the serviceperson to restock the vending machine with the new items carried to the vending machine before restocking the items previously offered by the vending machine to ensure that older items are vended before the newly restocked items. Accordingly, prior to the restocking event, a central server may transmit an indication to the vending machine indicating a number of items of each item type to be loaded into the vending machine and/or the dispensing modules 414 thereof.

In some embodiments, the controller 402 may analyze the indication to ensure that the unloading process is performed in an organized manner to prevent serviceperson error due to misplacing unloaded items. In these embodiments, the controller 402 may query the planogram 434 to determine that an item to be loaded into the dispensing module 414A is blocked by one or more items currently loaded into the dispensing module 414A. Accordingly, the controller 402 may query the planogram 434 to identify an alternate dispensing module 414 in which the blocking item can be temporarily loaded.

Subsequently, the controller 402 may provide one or more indications to the serviceperson to move the blocking item to the alternate dispensing module 414. For example, the controller 402 may cause an indication unit of the dispensing module 414A to indicate the presence of the blocking item (e.g., by causing the indication unit to emit red light). Similarly, the controller may cause an indication of the alternate dispensing module 414 to indicate the target location of the blocking item (e.g., by causing the indication unit to emit red light). The controller 402 may repeat this process until all of the blocking items have been temporarily relocated.

The signal diagram 400 begins when the scanner 417 scans an item (such as an item 102) to extract an item identifier. The item identifier may indicate an item type for the item and/or an identifier unique to the individual item. In one example, if the scanner 417 is a barcode scanner, the scanner 417 may be configured to detect the presence of a barcode (e.g., a linear barcode or a 2D barcode) disposed on an item via one or more image sensors. In this example, the scanner 417 is configured to decode the detected barcode to extract the item identifier. As another example, if the scanner 417 is a wireless communication scanner (e.g., an RFID scanner or a NFC scanner), the scanner 417 may be configured to detect a wireless communication signal from a tag placed on the item. In this example, the scanner 417 is configured to extract the item identifier from the wireless communication signal. The scanner 417 then sends (410) the extract item identifier to the controller 402.

Upon receipt of the item identifier from the scanner 417, the controller 402 is configured to query (415) the planogram 434 to identify the particular dispensing module 414 into which the item is to be loaded. In the illustrated example, the planogram 434 indicates that the item is to be loaded into the dispensing module 414A.

As described above, in some embodiments new items are to be loaded into the dispensing module 414A prior to items that were previously offered by the vending machine. Accordingly, in some embodiments, the planogram may first analyze the item identifier to determine whether the item is a new item or an item that was previously offered by the vending machine. If the item was previously offered by the vending machine, and there are additional new items to be loaded into the dispensing module 414A, the planogram 434 may instead return an error code indicating that a new item is to be restocked prior to the item scanned at signal 405. In response, the controller 402 may cause a display (such as the display units 212 or 213) to provide an indication of the error. In this scenario, the controller 402 may return to the start of the signal diagram 400 and await the scanning of an additional item.

If the planogram 434 determines that the item is to be loaded into the dispensing module 414A, the planogram 434 may return (420) an identifier corresponding to the dispensing module 414A to the controller 402. In response, the controller 402 issues (425) a command for the dispensing module 414A to activate its indication unit (such as the indication unit 256). Upon detecting the command, the dispensing module 414A may activate its indication unit in a manner that indicates that the item is to be loaded therein. For example, the dispensing module 414A may cause the indication unit to emit green light. In some embodiments, the controller 402 also causes a display to provide an indication of the location of dispensing module 414A with respect to the grid of dispensing modules (such as the grid 211).

At this point, the serviceperson is expected to load the scanned item into the dispensing module 414A. Because this is a manual process, occasionally the item will instead be loaded into the wrong dispensing module. For example, in one scenario, the serviceperson mistakenly loads the scanned item into the dispensing module 414B. In this scenario, a sensor (such as a sensor 258) of the vending machine detects the presence of the scanned item being loaded therein. In response, the dispensing module 414B transmits (430) an indication to the controller 402 that an item has been loaded therein.

In response to detecting that the scanned item was improperly loaded into the dispensing module 414B, the controller 402 may perform one or more remedial actions to indicate to the serviceperson that the scanned item was improperly loaded into the dispensing module 414B. One example action is to issue (435) a command for the dispensing module 414B to activate its indication in an alert mode (e.g., cause the indication unit to emit red light and/or strobe the emitted light). Another example action is issue (440) a command to the scanner 417 to lock out its scanning functionality. Yet another example action is to configure a display to indicate an error message.

At some point, the serviceperson loads the scanned item into the dispensing module 414A (e.g., in response to the dispensing module 414A activating its indication unit and/or in response to any remedial actions performed by the controller 402). A sensor (such as a sensor 258) of the vending machine detects the presence of the scanned item being loaded therein. In response, the dispensing module 414A transmits (445) an indication to the controller 402 that an item has been loaded therein. The controller 402 may then issue a command to cause the dispensing module 414A to activate a motor (such as the motor 253) in a reverse direction to move the item towards the back of the vending machine such that an additional item may be loaded therein. If the controller 402 performed any remedial actions, the controller 402 may issue commands to cause the corresponding components to return to a normal operating condition. Additionally, the controller 402 may create and/or update an item record for the scanned item such that the item record includes an indication of an identifier of the dispensing module 414A.

At this point, the controller 402 may return the beginning of the signal diagram 400 and await the scanning of an additional item. If the controller 402 provided instruction to temporarily relocate one or more blocking items, the controller 402 may additionally provide instructions to the serviceperson to return the blocking items back to the dispensing module 414A.

Referring now to FIG. 4B, illustrated is a flow diagram of an example method 450 for an assisted restocking process implemented at a vending machine, such as the vending machines 100, 200. The method 450 may include actions described with respect to the signal diagram 400. The vending machine may include (1) a plurality of dispensing modules (such as the dispensing modules 114, 214, 414) upon which items offered by the vending machine are placed, wherein the dispensing modules include (i) a motor (such as the motor 253) configured to activate a dispensing mechanism in a forwards direction or a reverse direction, and (ii) an indication unit (such as the indication unit 256); (2) a planogram database configured to store a planogram (such as the planogram 234) indicating an arrangement of the items offered by the vending machine with respect to the plurality of dispensing modules (3) a scanner (such as the scanners 217, 417) configured to detect an identifier associated with items to be loaded into the vending machine; (4) one or more non-transitory memories (such as the memory 240) configured to store a set of computer executable instructions; and (5) a controller (such as the controller 202, 402) coupled to the plurality of dispensing modules, the planogram database, the scanner, and the one or more non-transitory memories. To perform the example flow diagram 450, the controller may execute the set of computer executable instructions stored at one or more non-transitory memories.

The example flow diagram 450 begins at block 455 when the controller detects, via the scanner, a read event indicative of an item to be loaded, the read event indicating an item identifier. This may include actions described with respect to signals 405 and 410 of the signal diagram 400.

At block 455, the controller queries the planogram to identify a first dispensing module corresponding to the item identifier. This may include actions described with respect to signals 415 and 420 of the signal diagram 400. In some embodiments, the planogram corresponds the item to both of the first dispensing module and an adjacent dispensing module.

At block 460, the controller activates the indication unit of the first dispensing module. This may include actions described with respect to signal 425 of the signal diagram 400. If the planogram corresponded the item to both of the first dispensing module and an adjacent dispensing module, the controller may be configured to additionally activate the indication unit for the adjacent dispensing module. In some embodiments, the indication unit includes one or more light emitting diodes (LEDs) or a display screen. Accordingly, to activate the indication unit, the controller is configured to activate the one or more LEDs or depict an image on the display screen.

In some embodiments, the flow diagram includes confirming that the item was properly loaded into the first dispensing module. Accordingly, in some embodiments, the plurality of dispensing modules include a weight sensor (such as a sensor 258) disposed proximate to a front end of the dispensing module. In these embodiments, the controller may be configured to detect, via the weight sensor of the first dispensing module, that the item was loaded into the first dispensing module. This may include actions described with respect to signal 445 of the signal diagram 400. The controller may be further configured to analyze the planogram to determine that an additional item is to be loaded into the first dispensing module and control the motor of the first dispensing module to activate the dispensing mechanism in a reverse direction.

As described herein, the assisted restocking techniques may detect that an item has been loaded into the wrong dispensing module. Accordingly, in some embodiments, the controller is configured to detect, via the weight sensor of a second dispensing module, that the item was loaded into an incorrect dispensing module. In response, the controller may be configured to perform one or more of disabling the scanner, causing the indication unit of the second dispensing module to operate in an alert state, and present an alert via an output device of the vending machine. This may include actions described with respect to signal 430, 435, and 440 of the signal diagram 400.

In another aspect, the assisted restocking techniques may prevent the loading of expired items into the vending machine. Accordingly, the vending machine may include an item database (such as the inventory database 232) configured to store item records regarding individual items offered by the vending machine. For example, the item records may indicate the item identifier and an expiration date. Thus, to prevent the restocking of a second item that is expired, the controller may be configured to detect a second read event for the second item. In response, the controller may be configured to (i) query the item database using the item identifier indicated by the second read event, (ii) determine that the second item is expired based on the item record for the second item, and (iii) present an alert via an output device (such as the display units 212, 213) of the vending machine.

In some embodiments, the controller is configured to query the planogram to identify that the first dispensing module includes a blocking item blocking a position on the first dispensing module at which the item is to be placed. In this scenario, the controller may additionally query the planogram to identify a second dispensing module at which the blocking item can be temporarily placed and activate the indication unit of the second dispensing module. For example, the controller may activate the indication unit of the first dispensing module to indicate a presence of the blocking item and activate the indication unit of the second dispensing module to indicate a target dispensing unit for the blocking item. Accordingly, the controller may be configured to detect the read event subsequent to the blocking item being placed on the second dispensing unit.

It should be appreciated that while the foregoing describes applying the assisted restocking techniques to detect the correct loading of the items in the dispensing modules 414, similar techniques may be implemented to detect the correct arrangement of the dispensing modules relative to the plurality of mounting modules (such as the mounting modules 224). That is, some restocking events may include an update to the planogram that changes the arrangement of the dispensing modules 414 with respect to the mounting modules. Accordingly, the above techniques may also be applied to indicate (i) which dispensing module is to be removed from a mounting module, (ii) a mounting module at which a dispensing module is to be inserted, and (iii) any alerts associated with non-compliance therewith.

### Dual Dispensing Module Control

As described above, in some scenarios a planogram may call for an item to be placed across two dispensing modules. Accordingly, to vend such an item, the vending machine controller is configured to synchronously control the motors of both dispensing modules to advance the item towards the front of the vending machine. While the motors typically exhibit similar responses to the same control signal, over time wear and tear may cause the same control signal input to a motor may result in differing output displacement rates at which the dispensing module advances its dispensing mechanism. This is particularly a concern in modular vending machines where dispensing modules may be readily moved and rearranged, including between different vending machines. This difference in output displacement may result in items falling off the dispensing modules or otherwise impairing expected operation of the vending machine.

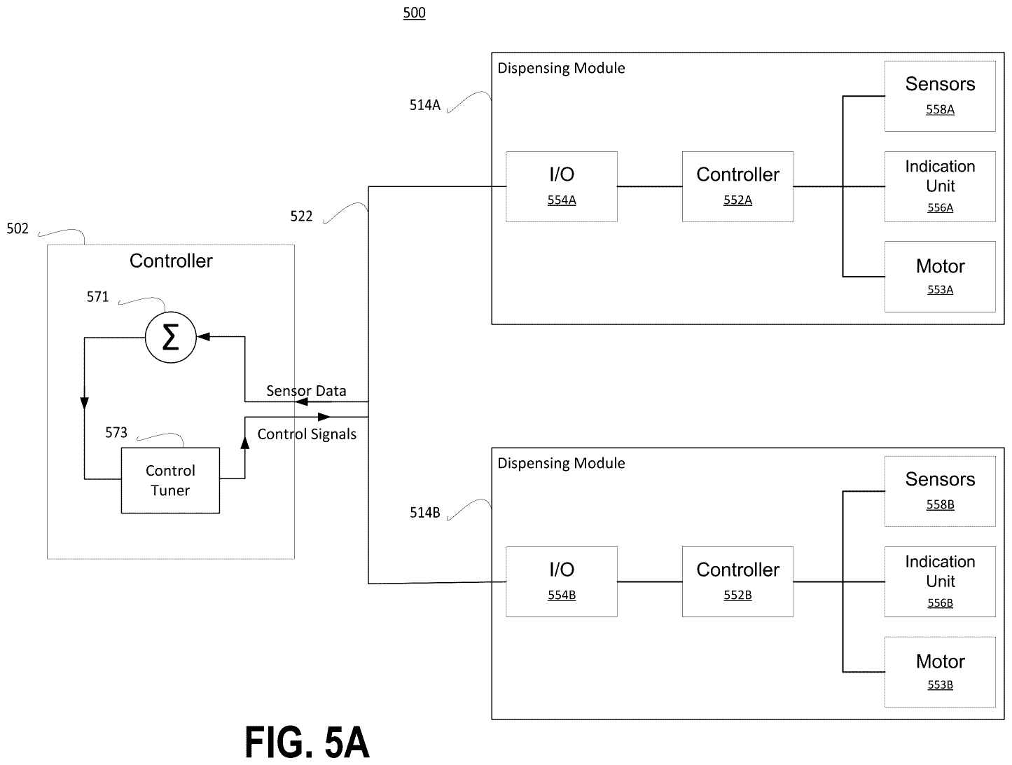

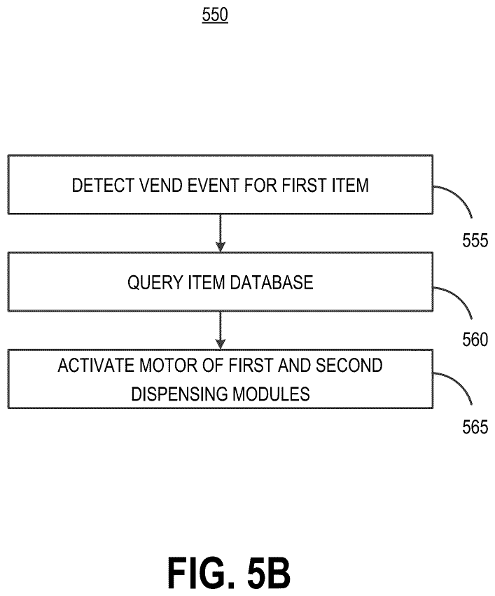

FIG. 5A is a block diagram of an example control system for synchronously operating two dispensing modules 514A, 514B (such as the dispensing modules 114, 214, 414) of a vending machine 500 (such as the vending machines 100, 200). The dispensing modules 514A, 514B include respective I/Os 554, controller 552, sensors 558, indication units 556, and motors 553 configured in the manner described with respect to FIG. 2B.

In the illustrated embodiment, a controller 502, such as the controllers 202, 402, is configured to synchronize the displacement of the dispensing mechanisms of the dispensing modules 514A, 514B using closed loop control techniques. As illustrated, the controller 502 includes a comparator 571 configured to compare outputs from the sensors 558A, 558B and a control tuner 573 configured to determine control values for operating the motor 553A, 553B. In some embodiments, the comparator 571 and the controller tuner 573 are implemented by a programmable logic controller (PLC) of the controller 502. Additionally or alternatively, the control tuner 573 may be implemented as a proportional-integral-derivative (PID) controller of the controller 502. In these embodiments, the PLC and/or the PID controller may be a different processing unit of the controller 502 than the processing unit (a CPU) that is configured to execute instruction to vend items in accordance with a point of sale (POS) application, such as the POS control application 246.

In response to detecting a customer interaction to vend an item placed on the dispensing modules 514A, 514B, the controller 502 is configured to issue a vend command over the bus 522 (such as the bus 222). The vend command may be configured to include an identifier of both the dispensing module 514A and the dispensing module 514B. Accordingly, in response to detecting the vend command being transmitted over the bus 522, the controllers 552A, 552B are configured to activate their respective motors 553A, 553B. As described above, the displacement of the dispensing mechanisms of the dispensing modules 514A, 514B may vary.

Accordingly, in the illustrated embodiment, the controllers 552A, 552B are configured to report an output of their respective displacement sensors 558A, 558B over the bus 522 when the respective motors 553A, 553B are active. The controller 502 detects the sensor data reports and routes the sensor data to the comparator 571, which determines a difference between the displacement values. This difference may be treated as an error signal that is used as an input to the control tuner 573. In embodiments where the control tuner 573, the control tuner 573 includes a set of programmable logic that converts the error signal into an adjustment to a control signal for operating one of the motors 553A, 553B. In embodiments where the control tuner 573 is a PID controller, the controller 502 may be configured to use the sensor data from the dispensing module 514A as the input signal, the sensor data from the dispensing module 514B as the setpoint value, and the error signal as the input error signal upon which typical PID processing is performed to generate an output control signal for operating the motor 553A. The controller 502 may be configured to output the control signals onto the bus 522 such that the indicated dispensing module 514 adjusts operation of its motor 553 in accordance therewith. As a result, the dispensing modules 514A, 514B exhibit synchronous displacement of their respective dispensing mechanisms.

In an alternate embodiment, rather than centrally synchronizing the displacement of the dispensing mechanism at the controller 502, each controller 552 may include a processing unit (e.g., a PLC or a PID controller) for closed loop control of each respective motor 553. In these embodiments, the controller 502 configures the controllers 552 of the dispensing module 514 with a global target displacement value. Accordingly, during a synchronous vend event, both the controller 552A and the controller 552B independently implement closed loop control of the motors 553A, 553B, respectively, using the global target displacement value as the setpoint value.

While the foregoing generally describes a control loop for operating the motor 553A and 553B when they are brushed DC motors, in other embodiments, the motors 553A and 553B are stepper motors. In these embodiments, the controller 502 may issue vend commands to control the motors 553A and 553B to synchronously advance the same number of steps when dispensing an item.

Referring now to FIG. 5B is a flow diagram for synchronous operation of two dispensing modules, such as the dispensing modules 114, 214, 414, 514 of a vending machine, such as the vending machines 100, 200. The vending machine may include (a) a plurality of dispensing modules upon which items offered by the vending machine are placed, wherein the dispensing modules include a motor configured to activate a dispensing mechanism in a forward direction or a reverse direction; (b) a planogram database configured to store a planogram indicating (i) an arrangement of a plurality of dispensing modules with respect to a plurality of mounting modules, and (ii) an arrangement of the items offered by the vending machine with respect to the plurality of dispensing modules, wherein the planogram indicates that a first item is to be placed across a first dispensing module and a second dispensing module, wherein the first dispensing module is adjacent to the second dispensing module; (c) an item database configured to maintain an item record for the items offered by the vending machine, wherein an item record for the first item includes an identifier of the first dispensing module and an identifier of the second dispensing module; (d) one or more non-transitory memories configured to store a set of computer executable instructions; and (e) a controller coupled to the plurality of conveyor modules, the planogram database, the item database, and the one or more non-transitory memories. To perform the example flow diagram 450, the controller may execute the set of computer executable instructions stored at one or more non-transitory memories.

The example flow diagram 550 begins at block 555 when the controller detects a vend event for the first item. For example, the controller may detect that the customer purchased the first item via one or more user interfaces presented by a primary display unit, such as the primary display unit 212.

At block 560, the controller queries the item database to obtain the identifier of the first dispensing module and the identifier of the second dispensing module. The controller may then generate a vend command that includes the obtained identifiers of the first and second dispensing modules.

At block 565, the controller activates the motor of the first dispensing module and the motor of the second dispensing module. For example, the controller may transmit the vend command over a system bus, such as the buses 222, 522, such that the vend command is received at the controllers of the plurality dispensing modules, such as the controllers 252, 552.

To improve the synchronicity of the displacement of the dispensing mechanisms caused by the activated motors, in some embodiments, the plurality of dispensing modules further include a displacement sensor configured to generate sensor data indicative of displacement of the dispensing mechanism.

In some embodiments, closed loop control of the motors is centrally performed by the controller. In these embodiments, the controller is configured to obtain sensor data from the displacement sensors of the first and second dispensing modules. The controller may then determine a difference between a displacement of a first dispensing mechanism of the first dispensing module and a second dispensing mechanism of the second dispensing module. Based on this difference, the controller determines an adjustment of an output of the motor of at least one of the first dispensing module or the second dispensing module to reduce the difference in displacement. Accordingly, the controller may include at least one of a programmable logic controller or a proportional-integral-derivative controller configured to determine the adjustment to an output of the motor. The controller may then output a control signal to adjust the output of the motor in accordance with the determined adjustment.

In other embodiments, closed loop control of the motors is performed at each dispensing module. Accordingly, the plurality of dispensing modules may further include a controller configured to implement closed loop control of the respective motors of the plurality of dispensing modules. In these embodiments, the controller of the vending machine may be configured to configure the controllers of the plurality of dispensing modules to utilize a target displacement value as a setpoint value for the closed loop control of the respective motors.

### Gantry Display

As described above, the vending machine may include a primary display unit, such as the display unit 212, configured to present user interfaces that guide a user through the point of sale (POS) process. Additionally, the vending machine may include a gantry system that includes a shelf adapted to receive purchased items from the dispensing modules of the vending machine. Our research has indicated that customers are more likely to purchase items (particularly fresh food items) when the particular item offered for sale is indicated to the user. That is, if multiple dispensing units include items offered for sale of the same type, the user benefits from knowing which dispensing unit will actually vend the item upon purchase. Accordingly, techniques disclosed herein relate to mounting a secondary display unit on the gantry system to provide a secondary user interface that improves the POS experience.

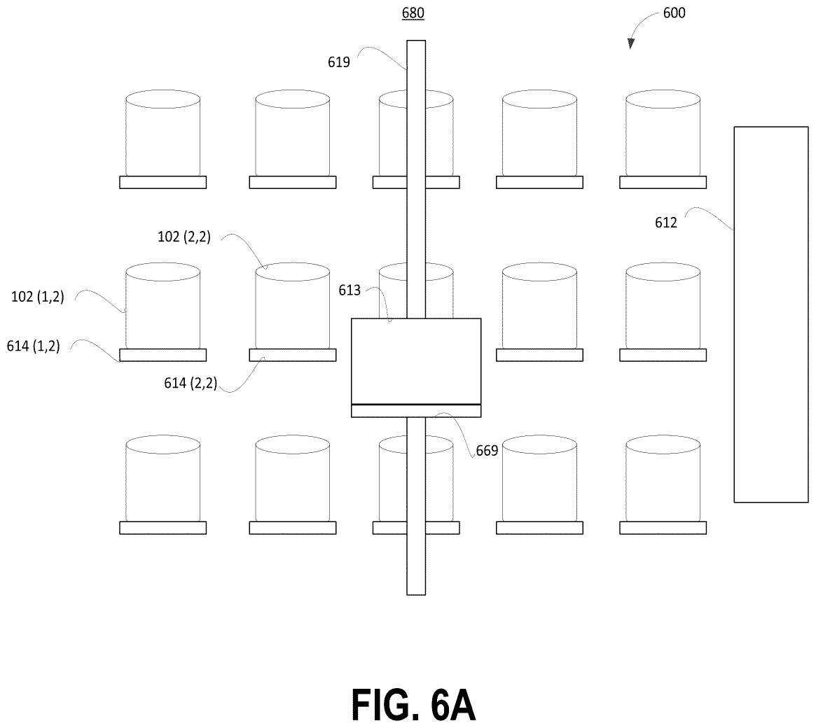

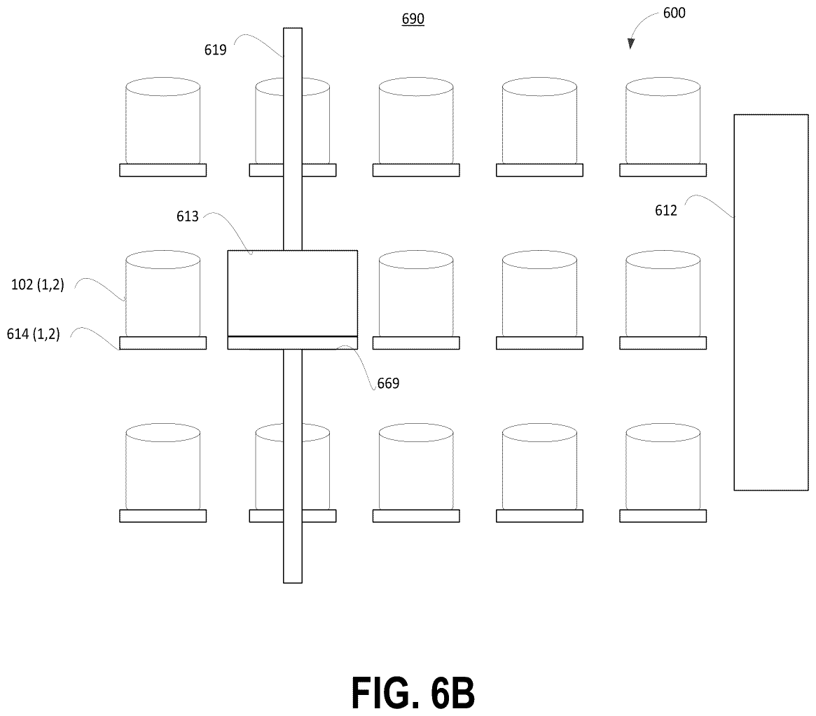

FIGS. 6A and 6B depict example arrangements 680, 690 of a vending machine 600, such as the vending machines 100, 200, 300, 400, 500, that includes a gantry system 619. The gantry system 619 includes a shelf 669 adapted to receive purchased items 102. Additionally, the gantry system 619 includes a secondary display unit 613, such as the secondary display unit 213, mounted to shelf 669 such that the gantry system 619 moves the secondary display unit 613 and the shelf 669 in tandem. The gantry system 619 also includes the arms and actuator components to physically move the shelf 669 within the housing of the vending machine 600. To this end, a gantry controller, such as the gantry controller 219, may be configured to control the actuators of the gantry system 619 to position the shelf 669 at a particular location. To avoid confusion, when the instant disclosure refers to the position of the gantry system 619, the referenced position should be understood as the configurable position of the shelf 669 and secondary display unit 613 tandem.

As illustrated, the vending machine 600 includes a plurality of dispensing modules 614, such as the dispensing modules 114, 214, 414, 514, having items for purchase 102 placed thereupon. The dispensing modules 614 are arranged in an X/Y grid pattern, such as the grid 211. The vending machine 600 also includes a primary display unit 612, such as the primary display unit 212, offset from the X/Y grid of dispensing modules 614. In some embodiments, the primary display unit 612 is built into a housing of the vending machine. In other embodiments, the primary display unit 612 overlaps at least a portion of the X/Y grid.

In operation, a controller of the vending machine, such as the controllers 202, 402, 502, executes a POS control application, such as the POS control application 246, to configure a primary user interface presented by the primary display unit 612 that guides a user through the POS process. For example, the controller may configure the primary display unit 612 to present a menu of the item types for purchase at the vending machine 600. In response to the user indicating a particular item type, the controller may be configured to present additional information to the user via the secondary display unit 613.

To improve the POS experience, in response to the user interaction with the menu, the controller may also be configured to position the gantry system 619 to be proximate to an item of the particular item type. Accordingly, the controller may be configured to query a planogram database, such as the planogram 234, 434, and/or an item database, such as the item database 232, to identify a dispensing module 614 that include items 102 of the particular item type and the X/Y position of the identified dispensing module 614 with respect to the X/Y grid. If there are multiple dispensing modules 614 that include items 102 of the particular item type, to reduce waste, the controller may obtain the X/Y position of the dispensing module 614 that includes the item 102 closest to expiring.

In response, the controller instructs the gantry controller to position the gantry 619 proximate to the identified X/Y position of the dispensing module 614. In the illustrated arrangements 680, 690, the dispensing module 614 (2, 2) storing item 102 (2, 2) is the identified dispensing module 614. In the arrangement 680 of FIG. 6A, the controller instructs the gantry controller to position the gantry 619 in a manner that avoids obscuring the item 102 (2, 2). While FIG. 6A depicts the item 102 (2, 2) being completely unobscured, in some embodiments, the item 102 (2, 2) may be up to 10%, up to 20%, or even up to 30% obscured while still being positioned in a manner that avoids obscuring. While the arrangement 680 depicts the gantry 619 being positioned to right of the item 102 (2, 2), the relative positioning of the gantry 619 and the items 102 may vary depending upon the location of the item 102 with respect to the X/Y grid and/or a prior position of the gantry 619. The controller may then configure the secondary display unit 613 to present a secondary user interface that indicates that the item 102 (2, 2) is the item 102 that will be purchased. For example, the secondary user interface may include an arrow, text, or other indication directing the user's attention to the item 102 (2, 2). Additionally, the controller may instruct the dispensing unit 614 (2, 2) to enable its indication unit, such as the indication units 156, 256, 456.

On the other hand, in the arrangement 690 of FIG. 6B, the controller instructions the gantry controller to position the gantry 619 in a position that completely obscures the item 102 (2,2). In this arrangement, the controller may configure the secondary user interface to present an image representative of the item 102 (2, 2). Accordingly, the positioning depicted in the arrangement 690 may be referred to as an “x-ray mode.”

In either scenario, the primary user interface 612 may enable the user to cycle between the items for purchase 102 of the particular item type. For example, if both the dispensing module 614 (1, 2) and the dispensing module 614 (2, 2) include an item 102 of the same item type, the primary interface may enable the user to indicate a desire to purchase the item 102 (1, 2), and not the item 102 (2, 2). In response, the controller instructs the gantry controller to move the gantry 619 to be proximate to the dispensing module 614 (1, 2).

It should be appreciated that if the user does complete a purchase for the item 102 (2, 2), the gantry 619 is already positioned proximate to the dispensing module 614 (2, 2). This enables the vending machine 600 to vend the item 102 (2, 2) in less time than a conventional vending machine.

### Additional Consideration

As mentioned above, aspects of the systems and methods described herein are controlled by one or more controllers. The one or more controllers may be adapted to run a variety of application programs, access and store data, including accessing and storing data in the associated databases, and enable one or more interactions as described herein. Typically, the controller is implemented by one or more programmable data processing devices. The hardware elements, operating systems, and programming languages of such devices are conventional in nature, and it is presumed that those skilled in the art are adequately familiar therewith.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompass systems such as host computers, cloud computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

What is claimed is:

1. A vending machine comprising:
a plurality of dispensing modules upon which items offered by the vending machine are placed, wherein the dispensing modules include (i) a motor configured to activate a dispensing mechanism in a forward direction or a reverse direction, and (ii) an indication unit;
a planogram database configured to store a planogram indicating an arrangement of the items offered by the vending machine with respect to the plurality of dispensing modules;
a scanner configured to detect an identifier associated with items to be loaded into the vending machine;
one or more non-transitory memories configured to store a set of computer executable instructions; and
a controller coupled to the plurality of dispensing modules, the planogram database, the scanner, and the one or more non-transitory memories, wherein the controller is configured to execute the set of computer executable instructions to:
detect, via the scanner, a read event indicative of an item to be loaded, the read event indicating an item identifier;
query the planogram to identify a first dispensing module corresponding to the item identifier; and
activate the indication unit of the first dispensing module.

2. The vending machine of claim 1, wherein:
the indication unit includes one or more light emitting diodes (LEDs) or a display screen; and
to activate the indication unit, the controller is configured to activate the one or more LEDs of the first dispensing module or depict an image on the display screen.

3. The vending machine of claim 1, wherein the plurality of dispensing modules further include a weight sensor disposed proximate to a front end of the dispensing module.

4. The vending machine of claim 3, wherein the controller is configured to:
detect, via the weight sensor of the first dispensing module, that the item was loaded into the first dispensing module.

5. The vending machine of claim 4, wherein the controller is configured to:
analyze the planogram to determine that an additional item is to be loaded into the first dispensing module; and
control the motor of the first dispensing module to activate the dispensing mechanism in a reverse direction.

6. The vending machine of claim 3, wherein the controller is configured to:
detect, via the weight sensor of a second dispensing module, that the item was loaded into an incorrect dispensing module.

7. The vending machine of claim 6, wherein the controller is configured to:
perform one or more of disabling the scanner, causing the indication unit of the second dispensing module to operate in an alert state, and present an alert via an output device of the vending machine.

8. The vending machine of claim 1, wherein the controller is configured to:
query the planogram to identify that the first dispensing module includes a blocking item blocking a position on the first dispensing module at which the item is to be placed;
query the planogram to identify a second dispensing module at which the blocking item can be temporarily placed; and
activate the indication unit of the second dispensing module.

9. The vending machine of claim 8, wherein to activate the indication unit of the first dispensing module and the indication unit of the first dispensing module, the controller is configured to:
activate the indication unit of the first dispensing module to indicate a presence of the blocking item; and
activate the indication unit of the second dispensing module to indicate a target dispensing unit for the blocking item.

10. The vending machine of claim 8, wherein the controller is configured to detect the read event subsequent to the blocking item being placed on the second dispensing unit.

11. A method of providing assisted restocking at a vending machine that includes (a) a plurality of dispensing modules upon which items offered by the vending machine are placed, wherein the dispensing modules include (i) a motor configured to activate a dispensing mechanism in a forward direction or a reverse direction, and (ii) an indication unit; (b) a planogram database configured to store a planogram indicating an arrangement of the items offered by the vending machine with respect to the plurality of dispensing modules; (c) one or more non-transitory memories configured to store a set of computer executable instructions; and (d) a controller coupled to the plurality of dispensing modules, the planogram database, the scanner, and the one or more non-transitory memories, the method comprising:
detecting, via a scanner communicative coupled to a controller of the vending machine, a read event indicative of an item to be loaded, the read event indicating an item identifier;
querying, via the controller, the planogram to identify a first dispensing module corresponding to the item identifier; and
activating, via the controller, the indication unit of the first dispensing module.

12. The method of claim 11, wherein:
the indication unit includes one or more light emitting diodes (LEDs) or a display screen; and
activating the indication unit comprises activating, via the controller, the one or more LEDs of the first dispensing module or depict an image on the display screen.

13. The method of claim 11, further comprising:
analyzing, via the controller, the planogram to determine that an additional item is to be loaded into the first dispensing module; and
controlling, via the controller, the motor of the first dispensing module to activate the dispensing mechanism in a reverse direction.

14. The method of claim 11, further comprising
querying, via the controller, the planogram to identify that the first dispensing module includes a blocking item blocking a position on the first dispensing module at which the item is to be placed;
querying, via the controller, the planogram to identify a second dispensing module at which the blocking item can be temporarily placed; and
activating, via the controller, the indication unit of the second dispensing module.

15. The method of claim 14, wherein activating the indication unit of the first dispensing module and the indication unit of the first dispensing module comprises:
activating, via the controller, the indication unit of the first dispensing module to indicate a presence of the blocking item; and
activating, via the controller, the indication unit of the second dispensing module to indicate a target dispensing unit for the blocking item.

16. The method of claim 11, further comprising:
detecting, via a sensor of a second dispensing module, that the item was loaded into an incorrect dispensing module; and
performing, via the controller, one or more of disabling the scanner, causing the indication unit of the second dispensing module to operate in an alert state, and present an alert via an output device of the vending machine.

17. A vending machine comprising:
a plurality of dispensing modules upon which items offered by the vending machine are placed, wherein the dispensing modules include (i) a motor configured to activate a dispensing mechanism in a forward direction or a reverse direction, and (ii) an indication unit;
a planogram database configured to store a planogram indicating an arrangement of a plurality of dispensing modules with respect to a plurality of mounting modules,
one or more non-transitory memories configured to store a set of computer executable instructions; and
a controller coupled to the plurality of dispensing modules, the planogram database, and the one or more non-transitory memories, wherein the controller is configured to execute the set of computer executable instructions to:
detect an event indicating that a previous planogram maintained at the planogram database is to be updated to a new planogram;
compare the previous planogram to the new planogram to identify a change in the arrangement of the plurality of dispensing modules with respect to the plurality of mounting modules; and
indicate, via the illumination units of the plurality of dispensing modules, the change in the arrangement of the plurality of dispensing modules with respect to the plurality of mounting modules.

18. The vending machine of claim 17, wherein:
the change is to remove a particular dispensing module from a particular mounting module; and
to indicate the change in the arrangement, the controller is configured to activate the indication unit for the particular dispensing module.

19. The vending machine of claim 18, wherein:
the change further includes coupling the particular dispensing module to a second mounting module; and
to indicate the change, the controller is configured to display an indication of the second mounting module via an output device of the vending machine.

20. The vending machine of claim 19, wherein the controller is configured to:
detect that the particular dispensing module was coupled to a mounting module other than the mounting module indicated by the new planogram; and
activate the indication unit for the particular dispensing module in an alert state.
